(19) United States
(12) Patent Application Publication
(10) Pub. No.: US 2002/0144014 A1
(43) Pub. Date: Oct. 3, 2002

(54) Event mediator for facilitating communication between isolated components

(76) Inventor: Alan West, Edinburgh (GB)

Correspondence Address: Cary S. Kappel, DAVIDSON, DAVIDSON & KAPPEL, LLC, 485 Seventh Avenue, 14th Floor, New York, NY, 10018, US

(21) Appl. No.: 09/771,244

(22) Filed: Jan. 26, 2001

(51) Int. Cl. G06F 9/46; G06F 15/163; G06F 9/54; G06F 9/00

(52) U.S. Cl. 709/318; 709/310

(57) ABSTRACT

A computer includes a plurality of components. Each component in a first sub-set of the plurality of components is operable to generate at least one of a plurality of events. Each component in a second subset of the plurality of components is configured to receive at least one of the plurality of events. A component mediator is provided which maintains an association between each component in the second sub-set and each of its corresponding events. Each component of the first sub-set notifies the component mediator when one of the events in generated by said each component, and the component mediator, in response to said notification, identifies, based on the maintained association, each component in the second sub-set which is associated with the notified event. The component mediator then forwards the notified event to the identified components in the second sub-set.

### FIELD OF THE INVENTION

This invention relates to a method for communicating events between components.

### BACKGROUND OF THE INVENTION

Computer programs can be organized as a plurality of components in accordance with object oriented programming principles. For example, a user interface could be organized as including a plurality of components (or views) and communication between components could be supported using “listeners” on target components which are notified when an event is generated from a source component. To facilitate this, the identity of each component having a listener for an event must be known to the component generating the event.

### SUMMARY OF THE INVENTION

A computer includes a plurality of components, which may include client components and server components, and a component mediator. The component mediator facilitates communication between components by acting as the sole interface for communication so that direct communication between components is eliminated, providing a standard interface for all components. The mediator can handle all communication between components as well as creating and destroying components, tracking the set of extant components, and broadcasting server and system events to interested components.

A method for facilitating communication is provided as well, comprising the steps of initiating communication between a sending component and a component mediator, transmitting information from the sending component to the component mediator, initiating communication with a receiving component and transferring the information from the component mediator to the receiving component.

The system maintains a set of events. In this regard, an event can be any occurrence within the system which a component may wish to be advised of. Examples of events could include the creation of a component, destruction of a component, setting of a break point, clearing of a breakpoint, editing of a breakpoint, changes in the menu or toolbar properties of a component, creation or deletion of objects within a component, and the like. Preferably, each component conforms to the JAVA bean definition of a component and each event has associated with it a listener. A listener is an interface in JAVA which defines the methods that a class implementing the interface should provide. Events are invoked (or fired) from a source component, and a plurality of “listener” components can be configured to be notified of the event.

In accordance with one embodiment of the present invention, a computer comprises a plurality of components, and each component in a first sub-set of the plurality of components is operable to generate at least one of a plurality of events. Each component in a second subset of the plurality of components is configured to receive at least one of the plurality of events. A component mediator is provided which maintains an association between each component in the second sub-set and each of its corresponding events. When an event is generated by one of the first sub-set of components, the component mediator is notified. In response, the component mediator, identifies each component in the second sub-set which is associated with the notified event, based on the maintained association. The component mediator then forwards the notified event to the identified components in the second sub-set.

In accordance with one aspect of this embodiment, each of the components in the second sub-set includes a call to an addEventListener method on the component mediator for each of its at least one of the plurality of events. In this regard, the “listener” is associated with its respective one of the plurality of events. The call to the event mediator to fire the event (e.g., pass the event to its registered listeners) preferably takes a set of properties as an argument. In accordance with another aspect of this embodiment, at least a sub-set of the events each have an associated property, and the component mediator forwards the notified event to a sub-set of the identified components in the second sub-set based upon a comparison between the property(ies) supplied as the argument to the fire event call and the property(ies) of the identified components in the second sub-set.

In accordance with yet another aspect of this embodiment, each component in the second sub-set of components has one or more objects, and each object implements a corresponding listener interface. The component mediator maintains a list associating each component-object pair with the type of the listener interface the object implements, and identifies each component and object pair with the notified event based upon its corresponding listener.

For example, if a particular component wishes to be advised of the occurrence of an event, the listener for the event is added by providing an object which implements the listener interface in the component which desires the information. The component mediator maintains, for each listener, a list of which components have which listener objects. When an event occurs in a component, the component mediator is notified of the event and derives the event's listeners therefrom. The properties, if any, associated with the event are supplied to the component mediator with the call to fire the event as described above. In this regard, the properties associated with the event may be dynamically generated and a different property could be associated with the event each time it is fired.

In any event, the component mediator examines its list of listener-component-object associations for a matching listener. If a match is found, the component mediator informs the corresponding object on the corresponding components that an event corresponding to its listener has occurred. In embodiments which utilize the properties feature of the present invention, the properties associated with the event are compared to the properties of each matched component, and only if the properties match, is the corresponding object on the component notified. In this regard, the properties of the component are “published”, i.e., available to the component mediator. It should be noted that the component mediator need not have any information regarding the events or components to perform this function. It need only know that a particular object on a particular component wishes to be notified when an event corresponding to a particular listener has occurred.

In accordance with the JAVA interface principles, an object in a component implements the listener interface that corresponds to the event of interest. However, in a conventional system, the component generating the event directly notifies the component having the listener that the event has occurred. To facilitate this, the identity of each component having a listener for an event must be known to the component generating the event. This architecture is problematic in that it requires the component generating the event to be modified each time a new component is added which wishes to be notified of the event.

By allowing the components to be isolated from each other, and simply knowing of the existence of the mediator, it allows each component to be developed independently of the others. For example, there is no need for the server component to know about the existence, or details, of a view component. This allows for coding and debugging, and upgrading each component separately. While mediation in general is a well known concept, this type of mediation has not been previously accomplished in the context of a component based development system.

The above-referenced architecture could, for example, be implemented in a system for developing and testing applications to be run on a target device. The system includes a host computer which can be coupled to the target device. The host computer includes a target server component for communicating with the target device and a plurality of client components for facilitating development and testing of applications for the target device. The client components could, for example, include a set of debugging component views for debugging an application on the target device, including a class hierarchy view component for displaying class hierarchies of the application, a class list view component for displaying a list of classes for the application, a source view component for displaying the source code for the application, a breakpoint view for viewing, setting, and clearing breakpoints, and a function list view component for listing the functions for the application. In accordance with the present invention, each of these components are isolated from eachother, and events generated in one component are propagated to other interested components via the component mediator. In this regard, for example, if a breakpoint is set in the breakpoint view component, this event would be reported to the component mediator which would forward the event, for example, to the target server component or other interested components.

### BRIEF DESCRIPTION OF THE DRAWINGS

FIG. 1 depicts a component mediator in accordance with a preferred embodiment of the present invention.

FIG. 2 depicts an arrangement of view components with a component mediator in accordance with an exemplary embodiment of the present invention.

### DETAILED DESCRIPTION OF THE PREFERRED EMBODIMENTS

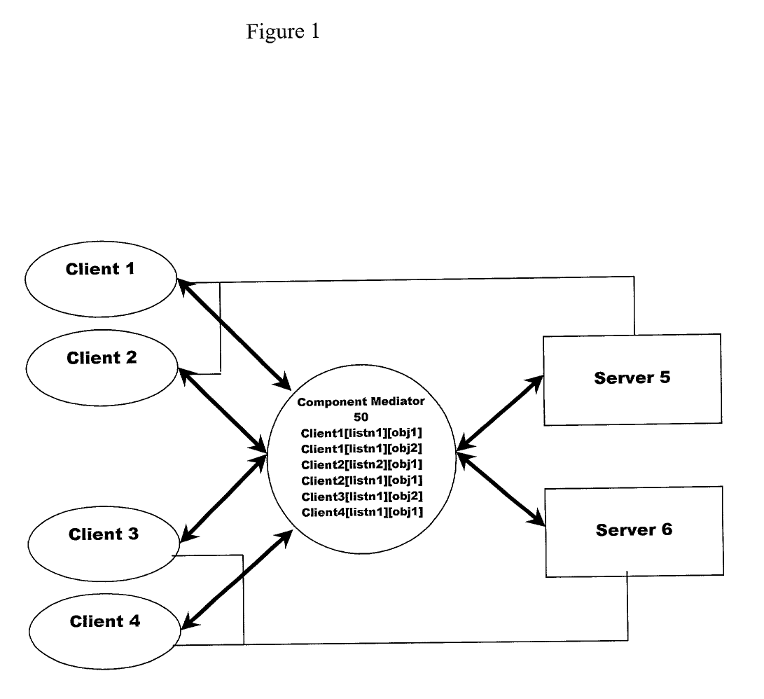

Referring to FIG. 1, there is shown a component mediator 50 according to a preferred embodiment of the present invention. The system includes a plurality of client components 1-4 and a plurality of server components 5-6 on a host computer. All communication between components is conducted through the mediator 50 so that interfacing with the mediator 50 is the only concern when developing component interfaces. In this way, direct communication between components is eliminated so that components do not have to be concerned with individual interfaces for remote machines and other components, in effect, allowing independent development and integration of applications, their corresponding client user interface components, and their corresponding server components by having the component mediator assume responsibility for creating and destroying components, tracing the set of extant components, and for broadcasting server and system events to interested components.

The client component architecture (CCA) of the preferred embodiment of the present invention is defined by a number of interfaces configured to work through the component mediator. The component mediator facilitates communication between components by acting as a liaison between components and transferring digital information in a form understood by the receiving component.

The present invention is preferably implemented with an object-oriented programming (OOP) language, such as Java. The present invention will be described in reference to a Java-based embodiment, however, it should be noted that any programming language with object-oriented principles can be used.

As one reasonably skilled in the relevant art will appreciate, classes are user-defined types in Java. Base classes are preferably provided to standardize typical implementations of client components and extension components. We will assume for purposes of illustration that the client component base class is named CCABase, and the extension component base class is provided, named CCAModifierBase. The base classes provide a number of services, including the implementation of the required interfaces, retrieval and storage of view properties, menu and toolbar generation, and facilities for cross-referencing other components. In addition, the base classes provide a template for view construction. To create a required, specific functionality, superclasses are used to override (i.e. modify) the base classes. Server components are similarly provided in a standard adapter class CCAServerAdapter and a base class CCAServerBase.

Throughout the following description, examples of Java code are provided to more clearly illustrate the invention. Names for classes, functions, methods and variables are arbitrarily chosen for their descriptive nature and to illustrate the principles of the present invention. Any name may be used according to well-known programming principles and the discretion of a developer using the present invention.

Standard clients are defined by a java source file and a properties file containing the specification of menus, accelerators, toolbars, tooltips and so forth for rapid modification and to support component internalization. The properties file is linked to the java source file because it is returned by the getPropertiesName( ) function, defined in CCABase and therefore incorporated in each view. The manner in which the properties file can be used to generate menus and toolbars is described in more detail in U.S. patent application Ser. No. __,___,___, filed Jan. 26, 2001, entitled “State and Data Driven Dynamic Menu and Toolbar Architecture” [Attorney Docket No. 218.1005], the entire disclosure of which is hereby incorporated by reference.

The components have a typical life cycle including creation, function, and termination. While functioning, the component accepts actions from a user and sends the corresponding command to the server. Events received from the server cause the component to make the appropriate updates in the display to reflect the server events. It will be appreciated that this is a somewhat simplified example of a life cycle, as user inputs can sometimes lead directly to screen updates (e.g., without server interaction) and events can sometimes result in invisible internal updates not reflected in the display.

Components may be built according to any well-known programming method with their interfaces adapted to operate with the component mediator in accordance with the present invention.

The code structure of a component typically includes three sections:

Event interface handlers—receive events broadcast from the component mediator.

View creation and updating methods—for changing the display, and action objects.

Action objects—respond to user input and typically issue commands to a server.

Event Interface Handlers

Event handlers are implementations of the available interfaces in the system. Each interface preferably involves two classes, a Listener class that defines the interface, and an Event class that defines arguments to the interface classes.

The Event class is used to communicate events between components through the component mediator. Examples of events might include set breakpoint, clear breakpoint, edit breakpoint, create view or dialog, destroy view or dialog, creation or destruction of a server, change in appearance of a view or dialog, etc.. The particular events which will be contained in any particular system will, of course, be dependent on the particular functions performed by the system and the types of information which needs to be shared among components. Each event is an extension of the Event class, CCAevent, and has associated with it a listener interface (e.g. implemented in the listening component by an object that implements the interface and calls the addEventListener method on the component mediator). Each event may also have a set of properties (e.g., the target server which generated the event) associated with it. As described above, these properties are provided as an argument to the fire event call.. Exemplary code for the class CCAevent is as follows:

TABLE 1

package wrss.cmediator.events;
import wrss.cmediator.components.CCAComponent;
import wrss.cmediator.components.CMediator;
import wrss.utils.X;
public abstract class CCAevent
{

protected Object sourceD;
protected int typeD;
protected boolean consumedD;
public CCAvent (Object source, int type)
{
sourceD = source;
typeD = type;
consumedD = false;

}
abstract public Class getListenerClass ()
public void send (CMediator cm, CCAComponent com, Object o)
{

X.reportFault(“ ”, defaulting to deprecated interface);
Send(cm,0)

}
public void consume()
{

consumedD = true;

}
public boolean isConsumed ()
{

return consumedD;

}
/**
* @deprecated
*/
public void send (CMediator cm, Object o)
{

X.reportFault (“ ”, “CCAevent.send called”);

}
public int getType () (return typeD;)
public Object getSource () {return sourceD; }
}

Exemplary code for a ACSevent (which handles breakpoint events) is as follows:

TABLE 2
package wrss.cmediator.events;
import wrss. cmediator.components.CCAComponent;
import wrss.cmediator.components.CMediator;
/**
* defines a breakpoint or filtering event
*/
public class ACSevent extends CCAevent
{

| | |
|---|---|
| public static final int ACS_FUNC_ENTRY_BP | = 4; |
| public static final int ACS_FUNC_EXIT_BP | = 5; |
| public static final int ACS_SL_BP_SET | = 6; |
| public static final int ACS_SL_BP_EDIT | = 7; |
| public static final int ACS_SL_BP_CLEAR | = 8; |

/**
* activity set that has changed
private int acsthingD;
/**
* whether the object is excluded
* and for a FUNC_ENTRY and EXIT whether it is set or reset
*/
private int valueD;
/**
* a query string which defines the affected set
* of objects
*/
private String queryD;
/**
* defines a breakpoint event
*
* @param type is the type of event
* @param activitySet defines the affected activity set
* @param value marks the object as excluded
* @param query defines the affected set of objects
*/
public ACSevent (int type, int activitySet, int value, String query)
{

super(null,type);
acsthingD = activitySet;
valueD = value;
if (query = = null)

queryD = null;

else

queryD = new String (query);

}
public int type() { return typeD; }
public String getQuery () { return queryD; }
public int getValue () { return valueD; }
public int getActivity Set () { return acsthingD; }
public void send (CMediator cm, CCAComponent com, Object o)
{

if (! (o instanceof ACSWaiter)) return;
ACSWaiter w = (ACSWaiter) o;
switch (typeD)
{
case ACS_FUNC_ENTRY_BP:w.onFunctionEntryBP(this);break;
case ACS_FUNC_EXIT_BP:w.onFunctionExitBP(this);break;
case ACS_SL_BP_SET:w.onSourceLineBPSet(this);break;
case ACS_SL_BP_EDIT:w.onSourceLineBPEdit(this);break;
case ACS_SL_BP_CLEAR:w.onSourceLineBPClear(this);break;
default:

x.reportFault (“ ”, “typeD” + typeD);
break;

}

}
public class getListenerClass () { return ACSWaiter.class; }
}

In accordance with the above, the component mediator calls the send function (send (CMediator cm, CCAcomponent corn, Object o)) which then sends the event to the receiving listener object in the receiving component. The getListenerClass function is used by the component mediator when an event is fired to match the event against the class of the listener objects in its list of listener-object-component associations.

If an object on another component is interested in being notified of a particular event, it calls the addEventListener method of the component mediator to add its listener object to the set of listener objects that the component mediator maintains. The component mediator maintains a list of which components have which listeners on which objects. When an event occurs, the component mediator is notified. Since the event is an extension of the CCAevent class, the Component mediator can derive the corresponding listener class from the event. It should be noted that an event may, or may not, have properties associated with it, and the properties of the event need not relate to the event itself (it could, for example, comprise properties of the components which, in the opinion of the event programmer, might be interested in the event). An example of an event property is the “target server” of a server generating the event. In any case, the component mediator derives the corresponding listener class from the event, and then determines whether there are any corresponding component listeners that wish to be advised of that event. If there are, the component mediator compares the properties of the event (if there are any) with the properties of the components having the corresponding component listeners, and, if there is a match, the component mediator sends the event to the object on that component which has that listener attached.

For example, the component mediator of FIG. 1 might have the following list of component-listener-object associations:

Client1[listn1][obj1]

Client1[listn1][obj2]

Client2[listn2][obj1]

Client2[listn1][obj1]

Client3[listn1][obj2]

Client4[listn1][obj1]

If a client component 3 generates an event1 which has associated therewith listener listn1, it will notify the component mediator that the event has occurred, and the component mediator will derive the listener class (listn1) and the properties (if any) of the event. The component mediator will then identify any component and object pairs which have listener listn1 installed.

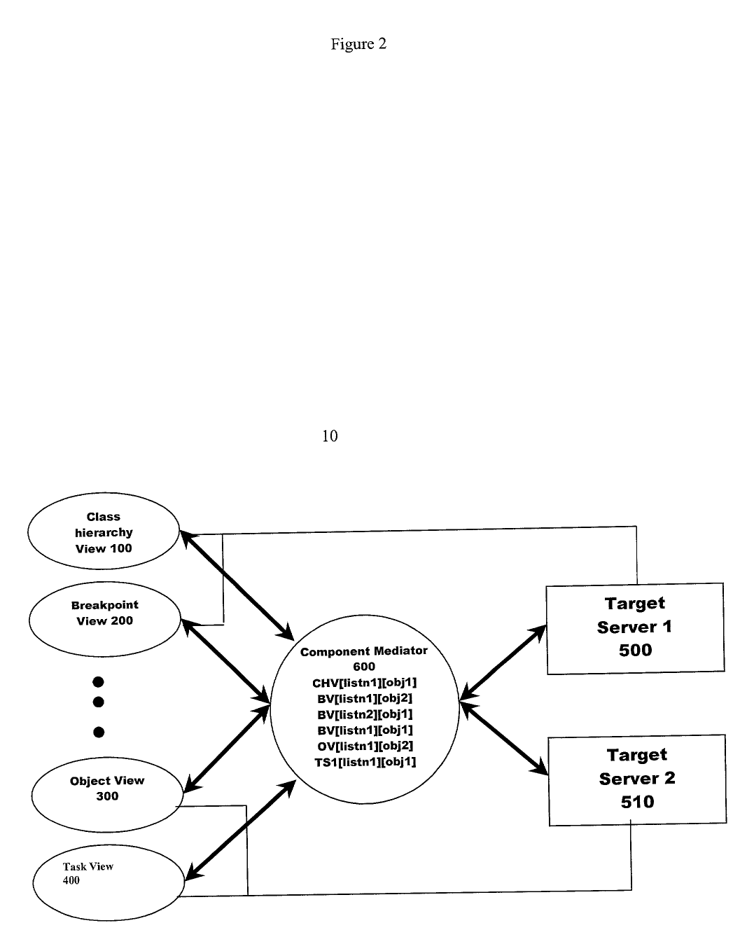

In this regard, FIG. 1 shows that objects 1 and 2 on client component 1, object 1 on client component 1, object 2 on client component 3, and object 1 on client component 4 have the listener listn1 . A listener is installed by having the listener object implement the listener interface. The listener defines only the listener class of interest. It does not identify any particular source for the event. The listener object is added to the component mediator by addEventListener and it implements the listener interface. As set forth above, the properties of the event can also be used by the component mediator to filter out component/object pairs which would not be interested in the event. For example, a system developer might not want a component relating to target server 5 to be notified of events for listener listn1 relating to target server 6. In the example, of FIG. 2, therefore, only object 1 on client component 4 would be notified of the event corresponding to listn1, because the event on client component 3 relates to target server 6. Objects 1 and 2 on client component 1, and object 1 on client component 2 would not be notified in this example because these components are associated with target server 5. Object 2 on client component 3 could similarly be excluded because there is presumably no need for the component mediator to notify a component of its own event.

If no properties were associated with listn1, then objects 1 and 2 on client component 1, object 1 on client component 2, and object 1 on client component 4 would be notified (assuming that the system policy is not to notify components of their own events).

Action Objects

Action objects are objects that control or cause some action to occur. For example, menus and toolbars consist of clickable objects that cause some processing to take place. When a user clicks on such an object, the appropriate action object corresponding to the clickable object executes the predetermined processing associated with the clickable object.

The component mediator in accordance with the present invention can be used in a variety of environments. For example, referring to FIG. 2, the above-referenced architecture could be implemented in a system for developing and testing applications to be run on a target device. The system includes a host computer 10 which can be coupled to one or more target devices (not shown). The host computer 10 includes a target server1 component 500 for communicating with a first target device, a target server 2 component 510 for communication with a second target device, and a plurality of client components 200-400 for facilitating development and testing of applications for the target device.

The client components could, for example, include a set of debugging component views for debugging an application on the target device, including a class hierarchy view 200 component for displaying class hierarchies of the application, a breakpoint view 300 for setting, clearing, and displaying breakpoints set on the application, an object view for listing the objects on the application, a task view for listing tasks being executed on the application 400, a class list view component for displaying a list of classes for the application (not shown), a source view component for displaying the source code for the application (not shown), and a function list view component for listing the functions for the application (not shown). In accordance with the present invention, each of these components are isolated from eachother, and events generated in one component are propogated to other interested components via the component mediator 600. In this regard, for example, if a breakpoint is set in the breakpoint view component 200, and the breakpoint view component sets breakpoints for an application running on target device 1 (corresponding to the target server 1 component), this event would be reported to the component mediator 600 which would forward the event, for example, to the target server 1 component 500 or other interested components . To implement this, any interested objects on other components than component 200 would include a call to addEventListener(listn1). The properties associated with such an event might include the target server on which the breakpoint is to be set. Upon being notified of a set breakpoint event, the component mediator 600 would determine that listn1 corresponds to that event, and would determine which objects/component pairs have that listener (in this case object 1 on Class Hierarchy View component 100, object 2 on the Breakpoint View component 200, object 2 on the Object View component 300, and object 1 on the Target Server 1 component 500. In this case, the event would be forwarded only to object 1 on component 100 and object 1 on component 500, because component 200 generated the event (and therefore need not be notified), and component 300 is associated with a different target server.

The present invention is also directed to any computer readable media having stored thereon the computer executable processes described above, including, without limitation, floppy disks, CD ROMs, tapes, hard disks, and the like.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computer comprising:
a plurality of components;
a first sub-set of the plurality of components, each component in the first sub-set being operable to generate at least one of a plurality of events;
a second sub-set of the plurality of components, each component in the second subset being configured to receive at least one of the plurality of events;
a component mediator, the component mediator maintaining an association between each component in the second sub-set and each of its corresponding events,
each component of the first sub-set notifying the component mediator when one of the events in generated by said each component;
the component mediator, in response to said notification, identifying, based on the maintained association, each component in the second sub-set which is associated with the notified event;
the component mediator forwarding the notified event to the identified components in the second sub-set.

2. The computer of claim 1, wherein the components conform to a JAVA bean component definition.

3. The computer of claim 2, wherein each of the components in the second sub-set includes a call to an addEventListener(listener) method on the component mediator for each of its at least one of the plurality of events, and wherein the listener is associated with its respective one of the plurality of events.

4. The computer of claim 1, wherein at least a sub-set of the events each are associated with a property, and wherein the component mediator forwards the notified event to a sub-set of the identified components in the second sub-set based upon the property associated with the notified event.

5. The computer of claim 3, wherein the component mediator derives the name of the listener from the event.

6. The computer of claim 1, wherein each component has one or more objects, and each object includes a call to an addEventListener(listener) method in the component mediator, the component mediator maintaining a list associating each component-object pair with its corresponding listener, and wherein the component mediator identifies each component and object pair with the notified event based upon its corresponding listener.

7. A method for facilitating communication between components on a computer comprising:
providing a plurality of components
in a first sub-set of the plurality of components, configuring each component to generate at least one of a plurality of events;
in a second sub-set of the plurality of components, configuring each component to receive at least one of the plurality of events;
maintaining, at a component mediator, an association between each component in the second sub-set and each of its corresponding events;
generating an event from the plurality of events from a component in the first subset;
receiving, at the component mediator, a notification the event has been generated by the component in the first sub-set;
in response to said notification, the component mediator identifying, based on the maintained association, each component in the second sub-set which is associated with the notified event; and
the component mediator forwarding the notified event to the identified components in the second sub-set.

8. The method of claim 7, wherein the components conform to a JAVA bean definition of a component.

9. The method of claim 7, wherein the step of configuring each component in the second sub-set includes providing a call to an addEventListener(listener) method on the component mediator in each component in the second sub-set for each of its at least one of the plurality of events.

10. The method of claim 9, further comprising providing an associated property for each of at least a portion of the components in the first sub-set, and wherein the component mediator forwards the notified event to only a sub-set of the identified components in the second sub-set based upon the property of the notified event.

11. A computer readable medium, having stored thereon, computer executable process steps for facilitating communication between components on a computer, comprising:
providing a plurality of components;
in a first sub-set of the plurality of components, configuring each component to generate at least one of a plurality of events;
in a second sub-set of the plurality of components, configuring each component to receive at least one of the plurality of events;
maintaining, at a component mediator, an association between each component in the second sub-set and each of its corresponding events;
generating an event from the plurality of events from a component in the first subset;
receiving, at the component mediator, a notification the event has been generated by the component in the first sub-set;
in response to said notification, the component mediator identifying, based on the maintained association, each component in the second sub-set which is associated with the notified event; and
the component mediator forwarding the notified event to the identified components in the second sub-set.

12. The computer readable medium of claim 11, wherein the components conform to a JAVA bean definition of a component.

13. The computer readable medium of claim 11, wherein the step of configuring each component in the second sub-set includes providing a call to an addEventListener(listener) method on the component mediator in each component in the second sub-set for each of its at least one of the plurality of events.

14. The computer readable medium of claim 13, further comprising providing an associated property for each of at least a portion of the components in the first sub-set, and wherein the component mediator forwards the notified event to only a sub-set of the identified components in the second sub-set based upon the property of the notified event.
